(19) United States
(12) Patent Application Publication
(10) Pub. No.: US 2026/0135218 A1
(43) Pub. Date: May 14, 2026

(54) AUTOMATIC FIRE EXTINGUISHING AND SUPPRESSION DEVICE FOR AN ELECTRIC VEHICLE BATTERY AND METHOD THEREOF

(71) Applicant: CHUNG-PING HSU, Taipei City (TW)

(72) Inventor: CHUNG-PING HSU, Taipei City (TW)

(21) Appl. No.: 19/383,657

(22) Filed: Nov. 8, 2025

(30) Foreign Application Priority Data
Nov. 8, 2024 (TW) 113143021

(51) Int. Cl. H01M 50/231; A62C 3/07; A62C 3/16; A62C 35/10; H01M 50/224; H01M 50/233; H01M 50/249; H01M 50/30

(52) U.S. Cl. CPC H01M 50/231; A62C 3/07; A62C 3/16; A62C 35/10; H01M 50/224; H01M 50/233; H01M 50/249; H01M 50/30; H01M 2200/10; H01M 2200/20

(57) ABSTRACT

An automatic fire extinguishing and suppression device for an electric vehicle battery includes an automatic fire extinguishing and suppression module for an electric vehicle battery module including at least one electric vehicle battery cell. The automatic fire extinguishing and suppression module is a multilayer packaging structure that includes a first automatic fire extinguishing and suppression inner layer, a first automatic fire extinguishing and suppression middle layer and an automatic fire extinguishing and suppression outer layer. The first automatic fire extinguishing and suppression middle layer includes a first fire extinguishing material filled under pressure, and a ventilation and heat dissipation space is formed between the first automatic fire extinguishing and suppression inner layer and the electric vehicle battery cell.

### CROSS REFERENCE TO RELATED APPLICATIONS

The present invention claims benefit of Taiwan Application No. 113143021, filed in Taiwan Intellectual Property Office on Nov. 8, 2024, the same disclosure of which is also filed in Chinese Notional Intellectual Property Administration on Nov. 8, 2024 as Chinese Application No. 202411587796.5, the disclosure of which is incorporated by reference herein.

### BACKGROUND OF THE INVENTION

### Field of the Invention

The present disclosure relates to an automatic fire extinguishing and suppression device and an automatic fire extinguishing and suppression method, particularly relates to an automatic fire extinguishing and suppression device and an automatic fire extinguishing and suppression method for an electric vehicle battery.

### Description of Related Art

With the rapid development of electric vehicles today, whether powered by purely electric drive or hybrid drive, a battery pack such as a lithium battery or a nickel-cobalt battery is commonly installed to serve as the power source for the motor. However, there is an increasing number of incidents worldwide where electric vehicles catch fire. Once an electric vehicle catches fire, it is not only difficult to extinguish, but firefighters often require substantially more water than for a traditional fuel vehicle to control fire. How to effectively extinguish a fire caused by an electric vehicle has become a growing critical issue for fire departments.

Because electric vehicle batteries store a large amount of energy, once thermal runaway of a battery occurs, massive amounts of heat is released instantly, with temperatures typically exceeding 600° C. to 1000° C. Conventional fire extinguishing equipment is often unable to extinguish the fire promptly, and special extinguishing materials and external forces are required to prevent the fire. However, due to safety and vehicle weight distribution considerations, the electric vehicle battery pack is typically installed on the vehicle's chassis, special extinguishing materials can't cool the battery pack directly. Firefighters are often forced to rely on pouring large amounts of water to cool down the pack and wait until the battery has fully reacted before the fire can be extinguished, which is extremely time-consuming and difficult. Therefore, once an electric vehicle battery spontaneously combusts or undergoes thermal runaway due to any cause, it is prone to causing a major accident or casualties.

As described above, the present disclosure provides a novel automatic fire extinguishing and suppression structure and an automatic fire extinguishing and suppression method to prevent the spread of fire throughout the entire battery pack and to avoid subsequent uncontrollable disasters such as thermal runaway, which is the problem intended to be solved.

### BRIEF SUMMARY OF THE INVENTION

An advantage of the present disclosure is that it does not require additional sensors or complex current blocking and protection devices. This design relies on the natural reaction of inherent characteristics of materials to initiate the fire suppression process, thereby requiring no external power supply or complex sensor deployment and monitoring. Accordingly, maintenance costs and the risk of failure can be reduced. The design of the present disclosure is capable of being configured in a modular structure that facilitates future maintenance, inspection, and battery replacement. In addition, the system can be configured in either a modular or an integrated design according to use requirements, thereby facilitating overall system design.

An automatic fire extinguishing and suppression device for an electric vehicle battery in accordance with the present disclosure is provided. The automatic fire extinguishing and suppression device for an electric vehicle battery includes an automatic fire extinguishing and suppression module for an electric vehicle battery module including at least one electric vehicle battery cell, wherein the automatic fire extinguishing and suppression module is an independent structure and may be disposed externally adjacent to the electric vehicle battery cell. The automatic fire extinguishing and suppression module is a multilayer packaging structure includes a first automatic fire extinguishing and suppression inner layer, a first automatic fire extinguishing and suppression middle layer; and an automatic fire extinguishing and suppression outer layer. The first automatic fire extinguishing and suppression middle layer is a sealed enclosed space having pressure resistance formed by the first automatic fire extinguishing and suppression inner layer and the automatic fire extinguishing and suppression outer layer. The sealed enclosed space is filled with a first fire extinguishing material under pressure, and a ventilation and heat dissipation space is formed between the first automatic fire extinguishing and suppression inner layer and the electric vehicle battery cell.

Furthermore, the first automatic fire extinguishing and suppression inner layer is a non-porous sealing layer configured to naturally form an opening in a melting region when heated, to release the encapsulated first fire extinguishing material.

Furthermore, the first automatic fire extinguishing and suppression inner layer is a first metal alloy layer.

Furthermore, the automatic fire extinguishing and suppression outer layer is a second metal alloy layer, and the melting point of the first metal alloy layer is lower than the second metal alloy layer.

Furthermore, the pressure in the first automatic fire extinguishing and suppression middle layer is more than 2 times the stored pressure.

Furthermore, the charging pressure in the first automatic fire extinguishing and suppression middle layer is at least 19 kgf/cm².

Furthermore, the melting point of the first metal alloy layer is in a range of about 200° C. to about 640° C.

Furthermore, the melting point of the second metal alloy layer is above 1200° C.

Furthermore, the first metal alloy layer is an aluminum alloy, including elements selected from the group consisting of aluminum, iron, silicon, copper, magnesium, yttrium, and vanadium.

Furthermore, the second metal alloy layer is stainless steel, including elements selected from the group consisting of nickel, chromium, manganese, silicon, and molybdenum.

Furthermore, the first fire extinguishing material is a solid fire extinguishing material.

Furthermore, the solid fire extinguishing material includes material selected from the group consisting of sodium bicarbonate, potassium bicarbonate, Ammonium dihydrogen phosphate, sodium chloride, graphite powder, and copper powder.

Furthermore, the multilayer packaging structure further includes a second automatic fire extinguishing and suppression inner layer and a second automatic fire extinguishing and suppression middle layer, disposed between the first automatic fire extinguishing and suppression middle layer and the automatic fire extinguishing and suppression outer layer. The second automatic fire extinguishing and suppression middle layer includes a second fire extinguishing material filled under pressure.

Furthermore, the first automatic fire extinguishing and suppression inner layer further comprises a first pressure monitor, and the second automatic fire extinguishing and suppression middle layer further comprises a second pressure monitor, and the first pressure monitor and the second pressure monitor are serial connected to each other.

Furthermore, the automatic fire extinguishing and suppression module is disposed externally adjacent to each of the electric vehicle battery cells in a one-to-one manner.

Furthermore, the automatic fire extinguishing and suppression module is disposed externally adjacent to the electric vehicle battery cells in a one-to-all manner, and is configured to enclose and protect all of the electric vehicle battery cells.

Furthermore, a plurality of the automatic fire extinguishing and suppression modules are disposed externally adjacent to each of the electric vehicle battery cells.

### BRIEF DESCRIPTION OF THE DRAWINGS

FIG. 1 is a perspective schematic view illustrating an automatic fire extinguishing and suppression device for an electric vehicle battery and an electric vehicle battery module installed on a vehicle frame according to an exemplary embodiment of the disclosure.

FIG. 2 is a cross-sectional schematic view taken along line A-A′ of the automatic fire extinguishing and suppression device for an electric vehicle battery and the electric vehicle battery module of the exemplary embodiment shown in FIG. 1.

FIG. 3 is a cross-sectional schematic view of an automatic fire extinguishing and suppression module for an electric vehicle battery, configured as a multilayer packaging structure according to an exemplary embodiment of the disclosure.

FIG. 4 is a cross-sectional schematic view of an automatic fire extinguishing and suppression device for an electric vehicle battery as a multilayer packaging structure according to another exemplary embodiment of the disclosure.

FIG. 5 is a schematic illustrating a method for implementing an automatic fire extinguishing and suppression device for an electric vehicle battery according to an exemplary embodiment of the disclosure.

FIG. 6 is a partial cross-sectional schematic view of an automatic fire extinguishing and suppression device for an electric vehicle battery including a plurality of automatic fire extinguishing and suppression middle layers and automatic fire extinguishing and suppression inner layers according to another exemplary embodiment of the disclosure.

FIG. 7 is a schematic view of an installed configuration of an automatic fire extinguishing and suppression device and an electric vehicle battery module according to an exemplary embodiment of the disclosure.

FIG. 8 is a cross-sectional schematic view taken along line B-B′ of the automatic fire extinguishing and suppression device for an electric vehicle battery and the electric vehicle battery module of the exemplary embodiment shown in FIG. 7.

### DETAILED DESCRIPTION OF THE INVENTION

In order to provide a clearer understanding of the present disclosure, several preferred embodiments are exemplified and illustrated in detail below in accompany with drawings so as to provide the public with an in-depth understanding and recognition of the present disclosure. It is noted that the embodiments described herein are exemplified and illustrated purposes only and are not intended to limit the scope of the present application. The present disclosure is further described in detail below to facilitate a thorough understanding of the present disclosure. However, the embodiments described are a portion of all possible embodiments, not all embodiments. All other embodiments that can be easily achieved by those with ordinary knowledge in the art based on the embodiments of the present disclosure are considered to fall within the scope of protection intended by the present disclosure.

The descriptions described below of “first”, “second”, etc., are used for descriptive purposes only and cannot be understood as indicating or implying their relative significance, or as implicit indication of a quantity of indicated technical features. Therefore, features defined and depicted as “first” and “second” may be considered explicitly or implicitly that at least one of the features is included. In the descriptions of some embodiments of the present disclosure, the terms “exemplary” or “for example” are used to illustrate or explain by way of example. Unless otherwise defined, all technical and scientific terms used herein have the same meaning as commonly understood by one with ordinary knowledge in the art to which the present disclosure belongs. The terminology used in the description of the present disclosure is only for the purpose of describing particular embodiments and is not intended to limit the scope of the present application.

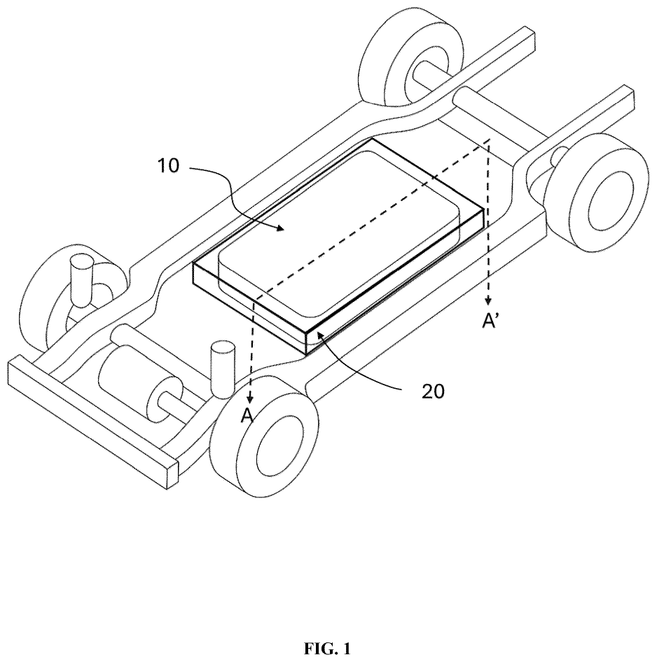

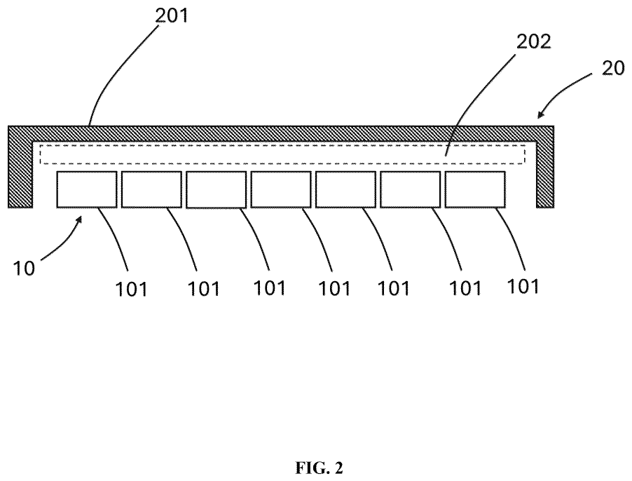

Please refer to FIG. 1, FIG. 1 is a perspective schematic view illustrating an automatic fire extinguishing and suppression device 20 for an electric vehicle battery and an electric vehicle battery module 10 installed on a vehicle frame according to an exemplary embodiment of the disclosure. FIG. 2 is a cross-sectional schematic view taken along line A-A′ of the automatic fire extinguishing and suppression device for an electric vehicle battery and the electric vehicle battery module of the exemplary embodiment shown in FIG. 1. The electric vehicle battery module 10 includes at least one electric vehicle battery cell 101, where the electric vehicle battery cells 101 may be connected in series (not shown) for operation. The automatic fire extinguishing and suppression device 20 for an electric vehicle battery includes an automatic fire extinguishing and suppression module 201. The electric vehicle battery automatic fire extinguishing and suppression module 201 is an independent structure and may be disposed at a position adjacent externally to the electric vehicle battery cell 101. A ventilation and heat dissipation space 202 is formed between the electric vehicle battery automatic fire extinguishing and suppression module 201 and the electric vehicle battery module 10. The ventilation and heat dissipation space 202 is a space where the electric vehicle battery automatic fire extinguishing and suppression module 201 and the electric vehicle battery module 10 are not in direct contact, so that air can circulate between them. The dashed-line region shown in the figure is illustrative only, and it is understood that in different embodiments, the shape of the dashed line may have different spatial shapes due to different designs of the electric vehicle battery module 10.

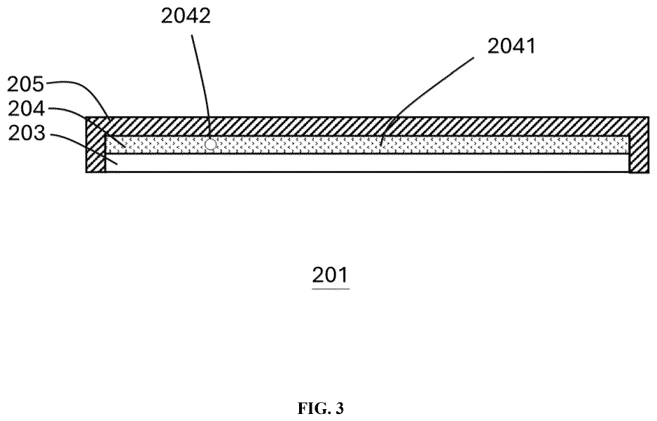

Please refer to FIG. 3, FIG. 3 is a cross-sectional schematic view of an automatic fire extinguishing and suppression module 201 for an electric vehicle battery, configured as a multilayer packaging structure according to an exemplary embodiment of the disclosure. The multilayer packaging structure includes a first automatic fire extinguishing and suppression inner layer 203, a first automatic fire extinguishing and suppression middle layer 204, and an automatic fire extinguishing and suppression outer layer 205. The first automatic fire extinguishing and suppression middle layer 204 is disposed between the first automatic fire extinguishing and suppression inner layer 203 and the automatic fire extinguishing and suppression outer layer 205. The first automatic fire extinguishing and suppression inner layer 203 is disposed on the side adjacent to the electric vehicle battery module 10. The first automatic fire extinguishing and suppression middle layer 204 is a pressure-resistant and sealed enclosed space defined and formed by the first automatic fire extinguishing and suppression inner layer 203 and the automatic fire extinguishing and suppression outer layer 205 (a partial cross-sectional schematic is shown in FIG. 3). The first automatic fire extinguishing and suppression middle layer 204 includes a first extinguishing material 2041 filled under pressure. The enclosed space is filled with the first extinguishing material 2041 under pressure. In other embodiments of the present disclosure, the first automatic fire extinguishing and suppression middle layer 204 may further include a first pressure monitor 2042. The first pressure monitor 2042 is configured to monitor and provide an alert. When the internal pressure of the first automatic fire extinguishing and suppression middle layer 204 changes, the first pressure monitor 2042 generates a first warning signal (not shown). For example, but not limited to, the first warning signal described above may be generated when the internal pressure of the first automatic fire extinguishing and suppression middle layer 204 drops below 100 psi. In other embodiments, the first warning signal may be generated when the internal pressure of the first automatic fire extinguishing and suppression middle layer 204 drops below 60 psi. It is understood that the setting of the threshold pressure may be adjusted according to actual application requirements. The purpose of the first pressure monitor is to inform the vehicle control unit that there is leakage or that a fire source has been generated in the electric vehicle battery module 10, and to generate a warning light or warning sound to alert the passengers. The above threshold pressure is not intended to limit the present disclosure.

The first extinguishing material 2041 described above is filled under pressure. The pressure value may be adjusted according to different extinguishing materials. For example, for mechanical foam fire extinguishers or dry chemical fire extinguishers, the extinguishers may be classified as either stored-pressure extinguishers or pressurized fire extinguishers. In one embodiment of the present disclosure, the pressure of the automatic fire extinguishing and suppression middle layer 204 for a stored-pressure extinguisher is preferably more than 2 times the stored pressure. The pressure may be, for example, but is not limited to, more than 2.1, 2.2, 2.3, 2.4, or 2.5 times the stored pressure, and most preferably more than 2.5 times the stored pressure. In another embodiment of the present disclosure, the charging pressure of the automatic fire extinguishing and suppression middle layer 204 for a pressurized fire extinguisher is preferably 19 kgf/cm² or more. The pressure may be, for example, but is not limited to, 19, 20, 21, 22, 23, 24, 25, 26, 27, 28, 29, 30, 31, 32, 33, 34, 35, or 36 kgf/cm² or more, and most preferably 36 kgf/cm² or more. When the stored pressure or charging pressure increases, the stressed planar area of the multilayer packaging structure may be increased. When the pressure decreases, the stressed planar area of the multilayer packaging structure should be limited to prevent the pressure per unit area becoming too low, resulting in incomplete release of the powder of the first extinguishing material 2041.

The first automatic fire extinguishing and suppression inner layer 203 is a first metal alloy layer, and the automatic fire extinguishing and suppression outer layer 205 is a second metal alloy layer. The first extinguishing material 2041 is enclosed and encapsulated between the first metal alloy layer and the second metal alloy layer. The melting point of the first metal alloy layer of the present disclosure is lower than the melting point of the second metal alloy layer. The melting point of the first metal alloy layer may be in a range of about 200° C. to about 640° C. The first metal alloy layer may be an aluminum alloy, including but not limited to one or two elements or alloys selected from the group consisting of aluminum, iron, silicon, copper, magnesium, yttrium, and vanadium. The first metal alloy layer may include, but is not limited to, the 7000 series (e.g., 7075), with a hardness (HB) of about 150-180 HB; the 2000 series (e.g., 2024), with a hardness (HB) of about 120-160 HB; and the 5000 series (e.g., 5052, 5083), with a hardness (HB) of about 60-85 HB. The component proportions of the aforementioned 2024 aluminum alloy are: Aluminum (Al): about 90.7%-94.7%; Copper (Cu): about 3.8%-4.9%; Magnesium (Mg): about 1.2%-1.8%; Manganese (Mn): about 0.3%-0.9%; with a melting point range of about 502° C. to about 638° C. For the 2014 aluminum alloy: component proportions are: Aluminum (Al): about 90.6%-94.7%; Copper (Cu): about 3.9%-5.0%; Magnesium (Mg): about 0.2%-0.8%; Manganese (Mn): about 0.4%-1.2%; Silicon (Si): about 0.5%-1.2%; with a melting point range of about 510° C. to about 635° C. The primary alloying element in the 7000 series aluminum alloys is zinc, and elements such as magnesium and copper are also included. The melting point range is usually between 475° C. to about 635° C. For the 7075 aluminum alloy: the component proportions are: Aluminum (Al): about 87.1%-91.4%; Zinc (Zn): about 5.1%-6.1%; Magnesium (Mg): about 2.1%-2.9%; Copper (Cu): about 1.2%-2.0%; Chromium (Cr): about 0.18%-0.28%; with a melting point range of about 477° C. to about 635° C. For the 7050 aluminum alloy: the component proportions are: Aluminum (Al): about 87.0%-91.0%; Zinc (Zn): about 5.7%-6.7%; Magnesium (Mg): about 1.9%-2.6%; Copper (Cu): about 2.0%-2.6%; Zirconium (Zr): about 0.08%-0.15%; with a melting point range of about 477° C. to about 635° C.

The melting point of the second metal alloy layer should exceed 1200° C. The second metal alloy layer is stainless steel, including one or more elements selected from the group consisting of nickel, chromium, manganese, silicon, and molybdenum. It may include, but is not limited to, 2205 stainless steel. The components of 2205 stainless steel are as follows: Chromium (Cr): about 21%-23%; Nickel (Ni): about 4.5%-6.5%; Molybdenum (Mo): about 2.5%-3.5%; Iron (Fe): about 63%-69% (balance); Nitrogen (N): about 0.14%-0.20%; with a melting point range of about 1350° C. to about 1400° C. The hardness of 2205 duplex stainless steel is as follows: Brinell hardness (HB): about 180-290 HB; Rockwell hardness (HRC): about 25-32 HRC; Vickers hardness (HV): about 180-310 HV. The mechanical properties of 2205 stainless steel are as follows: Tensile Strength: about 620-850 MPa; Yield Strength: about 450 MPa or more. Elongation: about 25%.

The melting point of the first metal alloy layer of the disclosure is lower than the temperature at which the electric vehicle battery module 10 catches fire or undergoes thermal runaway. The temperature of thermal runaway is typically between 600° C. and 1000° C. based on experience. The melting point of the first metal alloy layer of the disclosure may range from about 200° C. to about 640° C. When the melting point of the first metal alloy layer is lower than the thermal runaway temperature, the first metal alloy layer will melt first at the location of the fire source or high temperature, generating an opening and forming an ejection point. At this time, the first extinguishing material 2041 inside the first automatic fire extinguishing and suppression inner layer 203 will be ejected through the ejection point towards the high-temperature fire source region of the electric vehicle battery module 10 due to the pressure difference. The released first extinguishing material 2041 blocks and covers the high-temperature fire source region to achieve the effect of suppression and fire extinguishing. The first extinguishing material 2041 is a solid fire extinguishing material, including those selected from the group consisting of sodium bicarbonate, potassium bicarbonate, ammonium dihydrogen phosphate, sodium chloride, graphite powder, and copper powder.

The melting point of the second metal alloy layer is higher than the melting point of the first metal alloy layer and also higher than the temperature of the fire source and the chemical abnormal reaction of the electric vehicle battery module 10. When the electric vehicle battery module 10 catches fire or undergoes thermal runaway, the first metal alloy layer melts first at the fire source region or high-temperature region to form an opening, whereas the second metal alloy layer neither melts nor forms an opening. This achieves the purpose of ejecting the first fire extinguishing material 2041 directly toward the high-temperature fire source region of the electric vehicle battery module 10. The melting point of the second metal alloy layer should exceed 1200° C. The second metal alloy layer is made of stainless steel, including one or more elements selected from the group consisting of nickel, chromium, manganese, silicon, and molybdenum.

The ductility of the first metal alloy layer is greater than that of the second metal alloy layer. The first metal alloy layer having superior ductility can resist cracking or frictional damage under external impacts, and the metal alloy layer with high ductility also prevents penetration caused by external forces, thereby avoiding damage to the electric vehicle battery module 10. The first metal alloy layer may be an aluminum alloy, including one or more elements selected from the group consisting of aluminum, iron, silicon, copper, magnesium, yttrium, and vanadium. The rigidity of the second metal alloy layer is greater than that of the first metal alloy layer. The second metal alloy layer is made of a hard and impact-resistant material to resist external impacts and provide protection when the battery catches fire. The second metal alloy layer protects the first automatic fire extinguishing and suppression inner layer 203 and the first fire extinguishing material 2041 in the middle layer 204, preventing unintended leakage or ejection of the first fire extinguishing material 2041 due to external impact, deformation, or corrosion such as vehicle collisions. The second metal alloy layer is made of stainless steel or titanium alloy, including one or more elements selected from the group consisting of nickel, chromium, manganese, silicon, and molybdenum.

If the stored pressure or charging pressure of the automatic fire extinguishing and suppression middle layer 204 is insufficient, the first automatic fire extinguishing and suppression inner layer 203 may simultaneously melt at multiple locations when exposed to multiple fire sources or high-temperature points, thereby forming multiple openings and corresponding ejection points. In this situation, pressure differences among the jet points may result in uneven ejection, causing the first fire extinguishing material 204 to stop releasing at some openings with lower pressure before the first fire extinguishing material 2041 is fully released, thereby affecting the overall fire extinguishing efficiency. Furthermore, when the first fire extinguishing material 2041 is released from multiple openings, a frictional loss (pressure loss along the flow path) occurs during its flow. Such pressure attenuation becomes more significant when the openings are distant or when resistance exists in the path, leading to a decrease in release rate or even stagnation at certain ejection points. When the internal pressure is insufficient, the frictional loss further amplifies the uneven release phenomenon. Accordingly, in the present disclosure, the pressure differential and the frictional loss caused by multiple openings may be effectively compensated or avoided by increasing the stored or charging pressure, or by adopting a spliced modular configuration. This ensures that each opening maintains sufficient driving force to release the fire extinguishing material evenly and completely, thereby achieving a rapid and comprehensive extinguishing effect.

The multilayer packaging structure of the present disclosure is manufactured through an encapsulation process. First, the first automatic fire extinguishing and suppression inner layer 203, which is a first metal alloy layer, is formed to a desired size and shape through molding or sheet processing. Subsequently, the automatic fire extinguishing and suppression outer layer 205, which is a second metal alloy layer, is disposed on the outer side of the inner layer 203, wherein the automatic fire extinguishing and suppression outer layer 205 is precisely aligned and laminated according to a predetermined position and orientation on the outer side of the inner layer 203. Subsequently, a pressing process is performed under controlled temperature and pressure conditions and by using a press machine or rolling equipment, to ensure the inner layer 203 and the outer layer 205 are bonded along their edges to form a hermetically sealed enclosed space therebetween Finally, the sealing process is performed to seal the edges and joints using welding, brazing, or high-strength sealing adhesive, thereby forming a pressure-resistant and sealed enclosed space between the inner and outer layers, ensuring that the first automatic fire extinguishing and suppression middle layer 204 may withstand internal pressure and maintain the stability of the extinguishing material. The sealed enclosed space, which is the first automatic fire extinguishing and suppression middle layer 204, is defined between the first inner layer 203 and the outer layer 205. The first fire extinguishing material 2041 is filled into the sealed enclosed space under pressure during processing. Upon completion of the above lamination, pressing, and sealing steps, a multilayer packaging structure with a self-reactive fire extinguishing function is obtained. When an abnormally high temperature caused by a fire or chemical reaction occurs, the heat triggers the melting of the first automatic fire extinguishing and suppression inner layer 203 and forming an opening locally and thereby allowing the first fire extinguishing material 2041 within the middle layer 204 to be precisely released and sprayed out to suppress and extinguish the fire. By means of the encapsulation process described above, the middle layer is provided with a self-reactive fire-extinguishing function. Because of the forming of the multilayer structure by lamination and sealing of metal alloy layers, rather than a simple external packaging, its structural integrity, ease of deployment and assembly to fit existing batteries, and active safety protection effect are significantly superior to the existing technology. The multilayer structure is formed as a functional encapsulation through lamination and sealing of metal alloy layers, rather than by simple external package, thereby providing markedly enhanced structural integrity, improved compatibility and ease of assembly with existing battery modules, and superior active safety protection performance compared with the prior art.

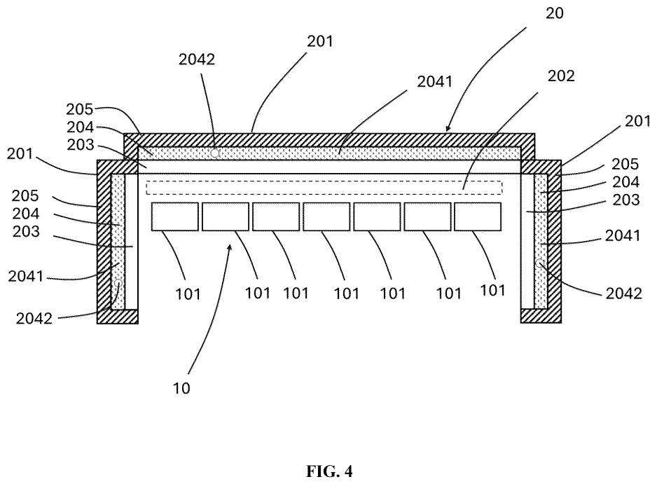

Referring to FIG. 4, FIG. 4 is a cross-sectional schematic view of an automatic fire extinguishing and suppression device 20 for an electric vehicle battery as a multilayer packaging structure according to another exemplary embodiment of the disclosure, wherein the automatic fire extinguishing and suppression device 20 is configured to envelop the electric vehicle battery module 10. In the embodiment, the electric vehicle battery automatic fire extinguishing and suppression device 20 include one top surface and a plurality of side surfaces formed by multiple automatic fire extinguishing and suppression modules 201, which are connected and affixed to each other by way of the automatic fire extinguishing and suppression outer layer 205. The fastening methods may include, but are not limited to, welding, bolts, buckles, bonding, or other equivalent mechanical fastening methods, so as to ensure structural stability and reliable sealing among the automatic fire extinguishing and suppression modules 201. Since the automatic fire extinguishing and suppression module 201 is designed as an independent unit with a modular configuration, the quantity and arrangement thereof can be flexibly adjusted according to the capacity, number of cells, or external shape of the electric vehicle battery module 10. For example, the modules 201 may be arranged linearly along the long or short side of the electric vehicle battery module 10, or alternatively, the modules 201 may be configured to surround the three-dimensional structure of the electric vehicle battery module 10 to achieve comprehensive protection. Furthermore, the shape of the electric vehicle battery automatic fire extinguishing and suppression module 201 may also be designed and adjusted based on the external contour of the electric vehicle battery module 10, such as rectangular, curved, or polygonal structures, to fully encloser the outer surface of the electric vehicle battery module 10. This ensures that when localized abnormal temperature rise occurs in the electric vehicle battery cell 101, the electric vehicle battery automatic fire extinguishing and suppression modules 201 maintain structural stability and reliable sealing therebetween, thereby enabling the electric vehicle battery automatic fire extinguishing and suppression modules 201 to more quickly sense and release the first fire extinguishing material 2041 at the corresponding position. Accordingly, the electric vehicle battery automatic fire extinguishing and suppression device 20 of the present disclosure provides high degree of modularity, scalability, and flexibility in configuration, thereby permitting customized configurations based on various battery module designs. Furthermore, the cooperative operation of multiple modules enhances the overall immediacy and comprehensiveness of the fire suppression effect.

Compared with the prior art, the multilayer encapsulation structure of the present disclosure can be manufactured independently of the battery module. The sealed enclosed spaces defined by the first automatic fire extinguishing and suppression inner layer 203, the first automatic fire extinguishing and suppression middle layer 204, and the automatic fire extinguishing and suppression outer layer 205 may be fabricated and sealed prior to integration with the battery module, thereby providing high modularity and manufacturing flexibility. This configuration not only facilitates adaptation to battery modules of various sizes or models but also simplifies the filling of extinguishing material, as well as local replacement, maintenance, and testing operations, thereby demonstrating the advantages of the present disclosure in both structural design and manufacturing process.

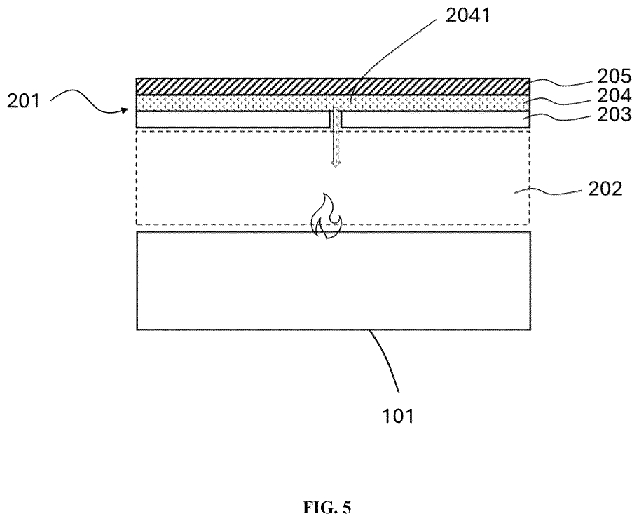

Referring to FIG. 5, FIG. 5 is a schematic illustrating a method for implementing an automatic fire extinguishing and suppression device 20 for an electric vehicle battery according to an exemplary embodiment of the disclosure, using the partial cross-sectional schematic view of the electric vehicle battery automatic fire extinguishing and suppression module 201 as a multilayer packaging structure shown in FIG. 3 for illustration. Partial ventilation and heat dissipation space 202 is formed between the first automatic fire extinguishing and suppression inner layer 203 and the electric vehicle battery cell 101. The multilayer packaging structure includes the first automatic fire extinguishing and suppression inner layer 203, the first automatic fire extinguishing and suppression middle layer 204, and the automatic fire extinguishing and suppression outer layer 205, wherein the first automatic fire extinguishing and suppression middle layer 204 includes the first fire extinguishing material 2041 filled under pressure. When thermal runaway occurs in the battery module and the temperature exceeds the melting point of the first automatic fire extinguishing and suppression inner layer 203, a portion of the first automatic fire extinguishing and suppression inner layer 203 melts and ruptures, thereby generating an opening and forming an ejection point. At this moment, due to the pressure difference, the first fire extinguishing material 2041 is ejected through the opening toward the electric vehicle battery cell 101 to block and cover the high-temperature fire source area, thereby achieving the effect of automatic suppression and fire extinguishing.

The present disclosure utilizes the melting characteristics of the first metal alloy layer of the first automatic fire extinguishing and suppression inner layer 203. When exposed to a high temperature generated by a fire or a chemical reaction, the first metal alloy layer naturally forms an opening at the heat source region, thereby exhibiting a self-reactive material design. As used herein, the term “self-reactive material design” refers to a configuration in which the material itself reacts under specific conditions (for example, when the temperature rises to a predetermined threshold temperature, or when exposed to open flame or high heat generated by a battery thermal runaway reaction), allowing the material to locally melt and form an opening and ejection point at the heat source without only relying on sensing devices or external control mechanisms. More specifically, this self-reactive material design enables rapid release of the first fire extinguishing material 2041 when heating, thereby achieving the effect of quickly extinguishing the fire source. Because the melting and subsequent formation of the opening in the metal alloy layer occur as a direct result of the intrinsic melting characteristics of the material. When an abnormal temperature rise occurs in any local battery cell or component, the adjacent material may automatically initiate the reaction without requiring additional sensors or control circuits, thereby effectively reducing fire-extinguishing response time. Furthermore, the self-reactive design allows the material to remain stable within the sealed enclosed space of the first automatic fire extinguishing and suppression middle layer 204, and to react only when triggered under critical conditions. This prevents loss of effectiveness or failure of the first fire extinguishing material 2041 under normal conditions, thereby ensuring long-term reliability and safety. Such an effect cannot be achieved by conventional designs that rely solely on physical isolation or passive heat-absorbing materials.

The first automatic fire extinguishing and suppression inner layer 203 of the present disclosure is a non-porous sealing layer that, upon heating, naturally forms an opening within a melting region to release the encapsulated first fire extinguishing material 2041. In other words, in its initial state, the first automatic fire extinguishing and suppression inner layer 203 does not include predetermined openings, switches, or channels configured for releasing the first fire extinguishing material 2041. Instead, it adopts a continuous coverage design composed of a single integral layer or multiple adjacent modules without any predetermined fixed release aperture or opening at specific locations. The purpose of this design is to eliminate the limitation of the extinguishing material being released only through a single or a limited number of release openings, which may otherwise cause a delay in fire suppression when the actual fire source does not match the predetermined release opening, switch, or channel. Through this configuration, the first automatic fire extinguishing and suppression inner layer 203 is capable of providing comprehensive protection against fire sources or abnormal high temperatures arising from different directions and areas. In practical operation, when a fire or high temperature occurs at a specific location, the first metal alloy layer of the first automatic fire extinguishing and suppression inner layer 203 undergoes localized melting or decomposition reaction at the heated region, forming a local melting region and subsequently generating an opening or rupture. This opening or rupture acts as a dynamic release opening corresponding to the actual fire source location, allowing the first extinguishing material 2041 filled in the first automatic fire extinguishing and suppression middle layer 204 to be immediately released and directly cover the fire source or high-temperature point, thereby achieving instantaneous and precise localized fire extinguishing and suppression. The position and number of such openings are not fixed in advance or predetermined, but are dynamically generated in real time according to the actual fire source and temperature distribution. By means of the aforementioned self-reactive melting mechanism of the material, the first extinguishing material 2041 can be precisely released to the area of the fire source, avoiding positional misalignment or reaction delay that could occur in designs having fixed release openings. This not only enhances the efficiency of the fire-extinguishing response but also ensures comprehensive protection and eliminates the need to predetermine the fire source location during design, thereby making the design particularly suitable for unpredictable abnormal conditions in battery systems.

As described above, there is not any predetermined opening included in the first automatic fire extinguishing and suppression inner layer 203 of the fire-extinguishing mode and the multilayer packaging structure of the present disclosure. Accordingly, the first automatic fire extinguishing and suppression inner layer 203 features an adaptive perforation mechanism, enabling the formation of openings at any location as needed based on different fire source positions and temperature distributions. This fundamentally avoids issues such as delayed or misaligned release, ineffective fire extinguishing due to the spread of fire or chemical reactions that may be caused by a conventional fixed through-hole design, and eliminates the need for complex detection and monitoring components and mechanisms. In other words, the first automatic fire extinguishing and suppression inner layer 203 of the present disclosure is an active-response, type full-coverage structure, that ensures rapid formation of openings at the location of a fire source, regardless of where it occurs, thereby releasing the fire-extinguishing material to extinguish and suppress the local fire and block heat transfer. This significantly enhances the safety and reliability of the system while substantially reduces the complexity of assembly and deployment.

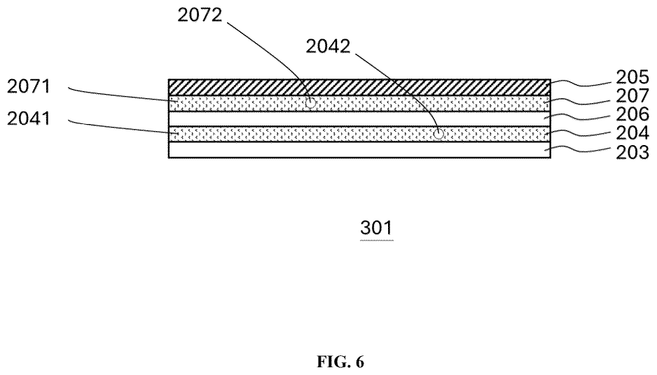

Referring to FIG. 6, FIG. 6 is a partial cross-sectional schematic view of an automatic fire extinguishing and suppression device 301 for an electric vehicle battery including a plurality of automatic fire extinguishing and suppression middle layers 204, 207 and automatic fire extinguishing and suppression inner layers 203, 206 according to another exemplary embodiment of the disclosure. In another embodiment of the present disclosure, an automatic fire extinguishing and suppression device 301 for an electric vehicle battery includes a first automatic fire extinguishing and suppression inner layer 203, a first automatic fire extinguishing and suppression middle layer 204, a second automatic fire extinguishing and suppression inner layer 206, a second automatic fire extinguishing and suppression middle layer 207, and an automatic fire extinguishing and suppression outer layer 205. The first automatic fire extinguishing and suppression middle layer 204 is disposed between the first automatic fire extinguishing and suppression inner layer 203 and the second automatic fire extinguishing and suppression inner layer 206. The second automatic fire extinguishing and suppression middle layer 207 is disposed between the second automatic fire extinguishing and suppression inner layer 206 and the automatic fire extinguishing and suppression outer layer 205. The first automatic fire extinguishing and suppression inner layer 203 is disposed on the side adjacent to the electric vehicle battery module 10, and no predetermined release openings, switches, or channels for the first fire extinguishing material are not included in the first automatic fire extinguishing and suppression inner layer 203. The first automatic fire extinguishing and suppression middle layer 204 is a pressure-resistant and hermetically sealed enclosed space defined by the first automatic fire extinguishing and suppression inner layer 203 and the second automatic fire extinguishing and suppression inner layer 206. The first automatic fire extinguishing and suppression middle layer 204 a first fire extinguishing material 2041 filled under pressure. The second automatic fire extinguishing and suppression middle layer 207 is a pressure-resistant and hermetically sealed enclosed space defined by the second automatic fire extinguishing and suppression inner layer 206 and the automatic fire extinguishing and suppression outer layer 205. The second automatic fire extinguishing and suppression middle layer 207 includes a second fire extinguishing material 2071 filled under pressure. No predetermined release openings, switches, or channels for the second fire extinguishing material are included in the second automatic fire extinguishing and suppression inner layer 2071.

In another embodiment of the present disclosure, the first automatic fire extinguishing and suppression 204 may further include a first pressure monitor 2042, and the second automatic fire extinguishing and suppression middle layer 207 may further include a second pressure monitor 2072. The first pressure monitor 2042 and the second pressure monitor 2072 are respectively configured to monitor the internal pressures of the first automatic fire extinguishing and suppression middle layer 204 and the second automatic fire extinguishing and suppression middle layer 207, and to provide corresponding warning signals. When the internal pressure in the first automatic fire extinguishing and suppression middle layer 204 changes, a first warning signal may be generated (not shown in the figure); similarly, when the internal pressure in the second automatic fire extinguishing and suppression middle layer 207 changes, a second warning signal may be generated (not shown in figure). The change in the internal pressure of the first automatic fire extinguishing and suppression middle layer 204 may include, but is not limited to, a condition where the internal pressure drops below 100 psi, at which point the first warning signal is generated. In other embodiments, the threshold of the internal pressure may be set at a pressure drop below 60 psi to generate the first warning signal. Similarly, the change of the second automatic fire extinguishing and suppression middle layer 207 may include, but is not limited to, a condition where the internal pressure drops below 100 psi, at which point the second warning signal is generated. In other embodiments, the threshold of the internal pressure may be set at a pressure drop below 60 psi to generate the second warning signal. It should be understood that the specific pressure thresholds may be adjusted according to actual operational requirements. The purpose of such monitoring is to notify the vehicle control system of potential leakage or fire occurrence within the electric vehicle battery module 10, thereby triggering visual and/or audible alarms for the passengers. The aforementioned pressure thresholds are provided merely as illustrative examples and are not intended to limit the scope of the present disclosure.

In one embodiment of the present disclosure, a method of automatic fire extinguishing and suppression for an electric vehicle battery is provided. The method includes: providing an automatic fire extinguishing and suppression module 301 for an electric vehicle battery module 10, the automatic fire extinguishing and isolation module 301 having a multilayer packaging structure including a first automatic fire extinguishing and suppression inner layer 203, a first automatic fire extinguishing and suppression middle layer 204, a second automatic fire extinguishing and suppression inner layer 206, a second automatic fire extinguishing and suppression middle layer 207, and an automatic fire extinguishing and suppression outer layer 205. The first automatic fire extinguishing and suppression middle layer 204 includes a first fire extinguishing material 2041 filled therein under pressure, and the second automatic fire extinguishing and suppression middle layer 207 includes a second and fire extinguishing material 2071 filled therein under pressure. When the temperature of the electric vehicle battery module 10 exceeds the melting point of the first automatic fire extinguishing and suppression inner layer 203, a portion of the first automatic fire extinguishing and suppression inner layer 203 melts and ruptures, thereby generating an opening and forming an ejection point. The first fire extinguishing material 2041 is ejected toward the battery module 10 through the ejection point due to the pressure difference. After the first fire extinguishing material 2041 is fully released, if the temperature of the battery module 10 still exceeds the melting point of the second automatic fire extinguishing and suppression inner layer 206, a portion of the second automatic fire extinguishing and suppression inner layer 206 melts and ruptures, thereby generating another opening and forming another ejection point. The second fire extinguishing material 2071 is subsequently released toward the battery module 10 through the other ejection point due to the pressure difference. The second automatic fire extinguishing and suppression inner layer 206 may be the aforementioned first metal alloy layer. The second fire extinguishing material 2071 may be identical to the first fire extinguishing material 2041.

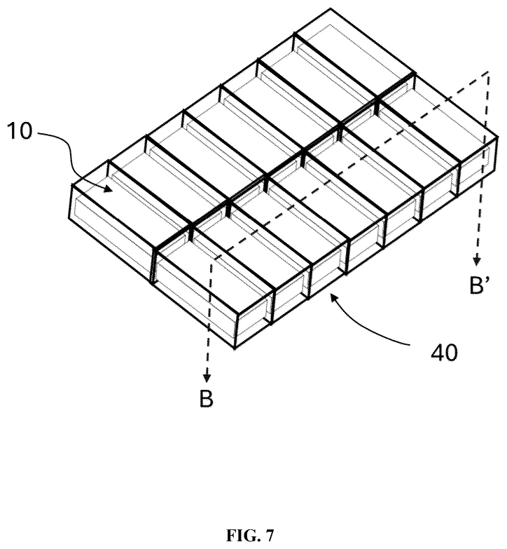

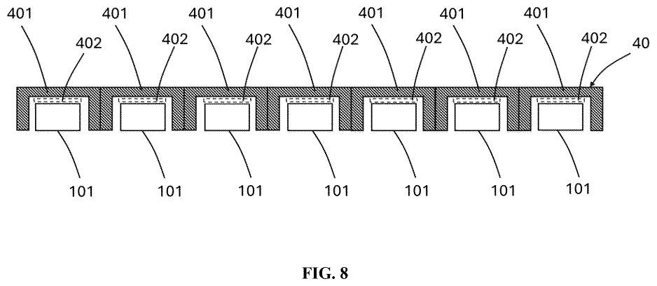

Referring to FIG. 7, FIG. 7 a schematic view of an installed configuration of an automatic fire extinguishing and suppression device 40 and an electric vehicle battery module 10 according to an exemplary embodiment of the disclosure. FIG. 8 is a cross-sectional schematic view taken along line B-B′ of the automatic fire extinguishing and suppression device for an electric vehicle battery and the electric vehicle battery module of the exemplary embodiment shown in FIG. 7. The automatic fire extinguishing and suppression device 40 includes an automatic fire extinguishing and suppression module 401. A ventilation and heat-dissipation space 402 is formed between the automatic fire extinguishing and suppression module 401 and the electric vehicle battery module 10. The ventilation and heat-dissipation space 402 means that the automatic fire extinguishing and suppression module 401 and the electric vehicle battery module 10 are not in direct contact, and a space is formed therebetween, thereby allowing airflow between them. The dashed-line area shown in the figure is provided merely as an example, and it should be understood that the shape and dimensions of the space may vary according to different designs of the electric vehicle battery module 10 in various embodiments. The embodiment illustrated in FIGS. 7 and 8 differs from those shown in FIG. 1, FIG. 2 and FIG. 6 in that the automatic fire extinguishing and suppression device 40 includes a plurality of automatic fire extinguishing and suppression modules 401 corresponding to the plurality of electric vehicle battery cells 101. The automatic fire extinguishing and suppression modules 401 may be serially connected to form an entire fire suppression panel a continuous fire prevention assembly. The first pressure monitor 2042 and/or the second pressure monitor 2072 may also be serially connected or shared to form an entire pressure monitoring panel an integrated pressure monitoring module (not shown in figure). The spliced modular configuration of this embodiment provides advantages such as preventing non-uniform powder ejection caused by uneven melting of the inner layers or avoiding reduced ejection performance resulting from large-area melting. Furthermore, the modular design facilitates subsequent maintenance and replacement of the electric vehicle battery, as well as compliance with practical wiring configurations.

It should be understood that the automatic fire extinguishing and suppression device and the automatic fire extinguishing and suppression module of the present disclosure may be arranged in a one-to-one manner externally adjacent to each the electric vehicle battery cell or their connecting components and modules; alternatively, the device and module may be arranged in a one-to-all manner externally adjacent to the electric vehicle battery cells or their connecting components and modules, thereby enclosing the electric vehicle battery cells to protect all of the electric vehicle battery cells; or a plurality of the modules and devices may be arranged externally adjacent to the electric vehicle battery cell or adjacent to its connecting components and modules. The automatic fire extinguishing and suppression device and method disclosed herein require no additional smoke or flame detectors, complex high-current monitoring and cut-off systems or protectors, and do not require the widespread deployment of fire extinguishing activation devices. The structure is simple and maintenance-free, and avoids the periodic inspection and replacement required by conventional fire extinguishing or smoke detection systems. The multilayer structure design provides mechanical strength and thermal protection, effectively resisting external impact and offering protection during battery fire events. The use of metallic powder, dry chemical powder, or stabilizers such as sodium chloride or graphite powder between the outer and inner layers allows active release and flame suppression upon the occurrence of a fire source. This simple yet effective design reduces the requirement for regular replacement and renewal of traditional fire extinguishing agents. This design relies on the natural reaction of inherent characteristics of materials to initiate the fire extinguishing process, requiring no external power supply or complex sensor deployment and monitoring, thereby reducing maintenance costs and failure risks. Furthermore, the design is capable of being configured in a modular structure that facilitates subsequent maintenance, inspection, and battery replacement. The design can utilize either a modular configuration or an integrated configuration depending on the use requirements, thereby facilitating overall system design.

What is claimed is:

1. An automatic fire extinguishing and suppression device for an electric vehicle battery, comprising:
an automatic fire extinguishing and suppression module for an electric vehicle battery module comprising at least one electric vehicle battery cell, wherein the automatic fire extinguishing and suppression module is an independent structure disposed externally adjacent to the electric vehicle battery cell, wherein the automatic fire extinguishing and suppression module is a multilayer packaging structure, comprising:
a first automatic fire extinguishing and suppression inner layer;
a first automatic fire extinguishing and suppression middle layer; and
an automatic fire extinguishing and suppression outer layer;
wherein the first automatic fire extinguishing and suppression middle layer is a sealed enclosed space having pressure resistance formed by the first automatic fire extinguishing and suppression inner layer and the automatic fire extinguishing and suppression outer layer; and
wherein the sealed enclosed space is filled with a first fire extinguishing material under pressure, and a ventilation and heat dissipation space is formed between the first automatic fire extinguishing and suppression inner layer and the electric vehicle battery cell.

2. The automatic fire extinguishing and suppression device for an electric vehicle battery as claimed in claim 1, wherein the first automatic fire extinguishing and suppression inner layer is a non-porous sealing layer configured to naturally form an opening in a melting region when heated, to release the encapsulated first fire extinguishing material.

3. The automatic fire extinguishing and suppression device for an electric vehicle battery as claimed in claim 2, wherein the first automatic fire extinguishing and suppression inner layer is a first metal alloy layer.

4. The automatic fire extinguishing and suppression device for an electric vehicle battery as claimed in claim 3, wherein the automatic fire extinguishing and suppression outer layer is a second metal alloy layer, and a melting point of the first metal alloy layer is lower than the second metal alloy layer.

5. The automatic fire extinguishing and suppression device for an electric vehicle battery as claimed in claim 4, wherein the pressure in the first automatic fire extinguishing and suppression middle layer is more than 2 times the stored pressure.

6. The automatic fire extinguishing and suppression device for an electric vehicle battery as claimed in claim 4, wherein the charging pressure in the first automatic fire extinguishing and suppression middle layer is at least 19 kgf/cm².

7. The automatic fire extinguishing and suppression device for an electric vehicle battery as claimed in claim 4, wherein the melting point of the first metal alloy layer is in a range of about 200°C. to about 640°C.

8. The automatic fire extinguishing and suppression device for an electric vehicle battery as claimed in claim 4, wherein the melting point of the second metal alloy layer is above 1200°C.

9. The automatic fire extinguishing and suppression device for an electric vehicle battery as claimed in claim 7, wherein the first metal alloy layer is an aluminum alloy, comprising elements selected from the group consisting of aluminum, iron, silicon, copper, magnesium, yttrium, and vanadium.

10. The automatic fire extinguishing and suppression device for an electric vehicle battery as claimed in claim 8, wherein the second metal alloy layer is stainless steel, comprising elements selected from the group consisting of nickel, chromium, manganese, silicon, and molybdenum.

11. The automatic fire extinguishing and suppression device for an electric vehicle as claimed in claim 1, wherein the first fire extinguishing material is a solid fire extinguishing material.

12. The automatic fire extinguishing and suppression device for an electric vehicle as claimed in claim 11, wherein the solid fire extinguishing material comprises material selected from the group consisting of sodium bicarbonate, potassium bicarbonate, Ammonium dihydrogen phosphate, sodium chloride, graphite powder, and copper powder.

13. The automatic fire extinguishing and suppression device for an electric vehicle as claimed in claim 1, wherein the multilayer packaging structure further comprises a second automatic fire extinguishing and suppression inner layer and a second automatic fire extinguishing and suppression middle layer, disposed between the first automatic fire extinguishing and suppression middle layer and the automatic fire extinguishing and suppression outer layer, and the second automatic fire extinguishing and suppression middle layer comprises a second fire extinguishing material filled under pressure.

14. The automatic fire extinguishing and suppression device for an electric vehicle as claimed in claim 13, wherein the first automatic fire extinguishing and suppression inner layer further comprises a first pressure monitor, and the second automatic fire extinguishing and suppression middle layer further comprises a second pressure monitor, and the first pressure monitor and the second pressure monitor are serial connected to each other.

15. The automatic fire extinguishing and suppression device for an electric vehicle as claimed in claim 1, wherein the automatic fire extinguishing and suppression module is disposed externally adjacent to each of the electric vehicle battery cells in a one-to-one manner.

16. The automatic fire extinguishing and suppression device for an electric vehicle as claimed in claim 1, wherein the automatic fire extinguishing and suppression module is disposed externally adjacent to the electric vehicle battery cells in a one-to-all manner, and is configured to enclose and protect all of the electric vehicle battery cells.

17. The automatic fire extinguishing and suppression device for an electric vehicle as claimed in claim 1, wherein a plurality of the automatic fire extinguishing and suppression modules are disposed externally adjacent to each of the electric vehicle battery cells.
